(19) United States
(12) Patent Application Publication
(10) Pub. No.: US 2012/0327163 A1
(43) Pub. Date: Dec. 27, 2012

(54) INK CARTRIDGE

(75) Inventor: Naoki Mizuno, Nagoya-Shi (JP)

(73) Assignee: BROTHER KOGYO KABUSHIKI KAISHA, NAGOYA-SHI (JP)

(21) Appl. No.: 13/530,532

(22) Filed: Jun. 22, 2012

(30) Foreign Application Priority Data
Jun. 24, 2011 (JP) 2011-140606

(51) Int. Cl. B41J 2/175

(52) U.S. Cl. 347/86

(57) ABSTRACT

This disclosure discloses an ink cartridge comprises a housing comprising a longwise direction, a shortwise direction, and a thickness direction, providing an observation opening on a lateral surface on one side of said housing in the longwise direction, a substantially bag-shaped reservoir portion that stores ink in its interior and is disposed within the housing so that the end portion of one side in the thickness direction contacts the housing, and a partition plate that extends so that it is disposed within the opening in the longwise direction, making it possible to visually check the reservoir portion interior from outside the housing.

### CROSS-REFERENCE TO RELATED APPLICATION

The present application claims priority from Japanese Patent Application No. 2011-140606, which was filed on Jun. 24, 2011, the disclosure of which is incorporated herein by reference in its entirety.

### BACKGROUND OF THE INVENTION

1. Field of the Invention

The present invention relates to an ink cartridge that contains ink.

2. Description of the Related Art

Ink cartridges that are generally known comprise an ink bag that contains ink in its interior, a plug for extracting the contained ink from the ink bag, and a right-angled parallelepiped-shaped plastic case configured to house the ink bag.

### SUMMARY OF THE INVENTION

The ink cartridge of the above-described prior art reference is provided with an opening on the housing. A needle that pierces into the rubber stopper of the plug and introduces the ink within the reservoir portion passes through the opening. While the plug can be visually checked from this opening, visually checking the volume of ink within the reservoir portion is difficult.

When an opening that enables visual confirmation of the reservoir portion is provided, the possibility exists that foreign matter will enter the housing interior from the opening during transport prior to sale or during handling by the operator after sale. Further, the possibility exists that the bag-shaped reservoir portion will incur damage or breakage by the shape or size of the foreign matter or its speed of entry.

It is therefore an object of the present invention to provide an ink cartridge capable of preventing entry of foreign matter and maintaining the visibility of the reservoir portion within the housing for the operator.

### Means for Solving the Problems

In order to achieve the above-described object, there is provided an ink cartridge for supplying ink, comprising: a housing having a longwise direction, a shortwise direction orthogonal to the longwise direction, and a thickness direction respectively orthogonal to the longwise direction and the shortwise direction, that has an opening to a lateral surface on one side of the housing in the longwise direction; and a substantially bag-shaped reservoir portion configured to store the ink in its interior, disposed within the housing so that an end portion in the thickness direction contacts the housing; and a partition plate configured to extend so as to be disposed within the opening along the longwise direction, so that it is possible to visually check an interior of the reservoir portion from an outside of the housing.

The ink cartridge according to the first aspect of the present invention is used with the longwise direction and thickness direction of the housing substantially horizontal, and the shortwise direction substantially vertical. A reservoir portion is provided in the housing interior, and this reservoir portion stores ink. The reservoir portion is bag shaped and is disposed so that the end portion in the thickness direction contacts the housing. As a result, the reservoir portion comprises a shape wherein the liquid level increases in height in proportion to the high volume of in ink in its interior, bulging in the above-described thickness direction, that is, the substantially horizontal direction. Conversely, the reservoir portion comprises a shape wherein the liquid level decreases in height in proportion to the decrease in ink in its interior, shrinking in the above-described thickness direction, that is, the substantially horizontal direction.

According to the first aspect of the present invention, the opening is provided on a lateral surface of one side of the housing in the longwise direction, making it possible for the operator to visually check such behavior of the liquid level and such behavior of the bag-shaped reservoir portion from the housing exterior. With this arrangement, the operator can visually check the interior of the reservoir portion from the housing exterior through this opening.

When such an opening is provided as described above, the possibility exists that foreign matter will enter the housing interior from the opening during transport prior to sale or during handling by the operator after sale. Then, the possibility exists that the bag-shaped reservoir portion will incur damage or breakage by the shape or size of the foreign matter or its speed of entry.

According to the first aspect of the present invention, an extended partition plate is extended inside the opening substantially horizontally so that it is disposed within the opening in the longwise direction of the housing. With this arrangement, it is possible to prevent such entry of foreign matter and maintain the visibility of the reservoir portion for the operator.

### BRIEF DESCRIPTION OF THE DRAWINGS

FIG. 1 is a perspective view showing the general configuration of the printer to which the ink cartridge of one embodiment of the present invention is applied, as viewed from the front.

FIG. 2 is a perspective view showing the outer appearance of the ink cartridge of one embodiment of the present invention, as viewed from the rear.

FIG. 3 is an exploded perspective view of the housing of the ink cartridge.

FIG. 4 is a rear view of the ink cartridge.

FIG. 5 is a front view of the ink cartridge.

FIG. 6 is a perspective view of the ink cartridge, as viewed from the rear.

FIG. 7 is a side view showing the ink pack and housing main body.

FIG. 8 is a horizontal sectional view of the ink cartridge.

FIG. 9 is a longitudinal sectional view of the main parts, showing the rear of the cartridge mounting portion of the housing of the printer.

FIG. 10 is a cross-sectional view showing the cross-sectional structure of the cross-section X-X′ of FIG. 8, with the ink pack removed.

FIG. 11A is an explanatory view explaining a comparison example in which the partition plate is vertically disposed, causing a decrease in visibility when checking the reservoir portion.

FIG. 11B is an explanatory view explaining a comparison example in which the partition plate is vertically disposed, causing a decrease in visibility when checking the reservoir portion.

FIG. 11C is an explanatory view explaining a comparison example in which the partition plate is vertically disposed, causing a decrease in visibility when checking the reservoir portion.

FIG. 12 is an explanatory view for explaining that the partition plate of the embodiment does not cause a decrease in visibility when checking the reservoir portion.

FIG. 13 is a side view showing a modification example in which the partition plate is provided to the cover.

FIG. 14 is a side view showing the housing main body in which a modification example of the partition plate rotatably supported at a lower end portion is installed.

FIG. 15 is a perspective view showing the modification example of the partition plate shown in FIG. 14.

FIG. 16 is an explanatory view indicating the rotating behavior of the partition plate shown in FIG. 14.

### DETAILED DESCRIPTION OF PREFERRED EMBODIMENTS

The following describes one embodiment of the present invention with reference to accompanying drawings.

### <Printer Overview>

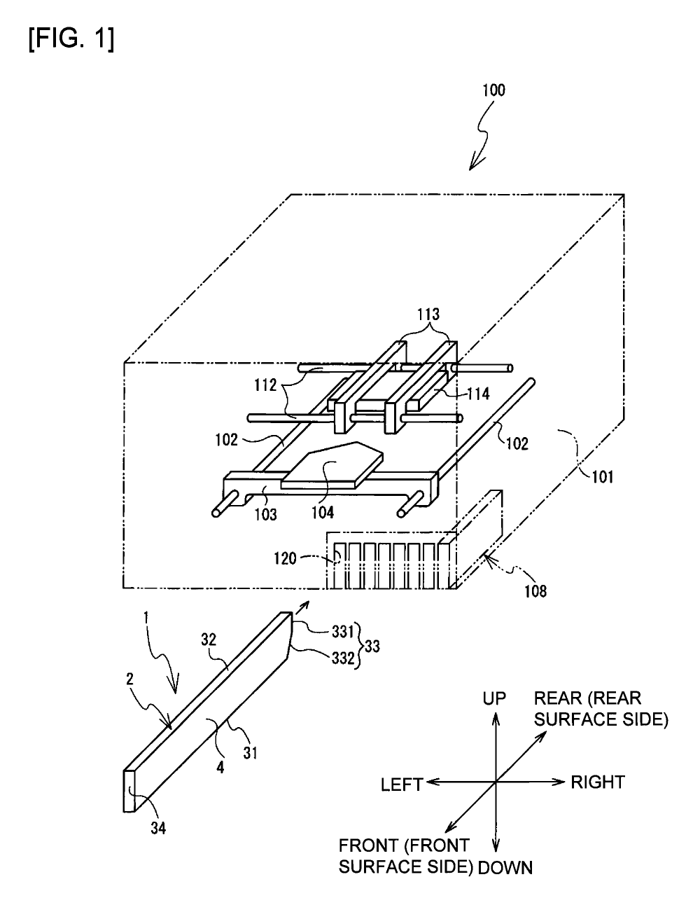

The following describes the printer used in this embodiment, using FIG. 1. Note that, in the following description, the vertical (up/down) direction, front-rear direction, and horizontal (right/left) direction correspond to the directions of the arrows suitably shown in each figure. As shown in FIG. 1, a printer 100 used in this embodiment is an inkjet printer that uses ink supplied from an ink cartridge 1 and performs printing on fabric such as a T-shirt, for example, via a printhead 114.

This printer 100 comprises a platen 104, the above-described printhead 114, a carriage 113, a pair of guide bars 112, and a carriage drive mechanism within a box-shaped housing 101.

The platen 104 sets and horizontally supports the fabric (not shown). The printhead 114 discharges ink supplied from the ink cartridge 1 onto the fabric supported by the platen 104, printing letters, images, etc., on the fabric. The carriage 113 holds the printhead 114 and moves the printhead 114 back and forth to the left side and the right side in FIG. 1. The guide bars 112 guide the carriage 113 horizontally. The carriage drive mechanism includes a carriage drive motor (not shown) that drives the carriage 113 along the guide bars 112.

Eight cartridge mounting portions 108 that extend in the front-rear direction are provided to a lower location near the front right of the housing 101. A cartridge insertion port 120 of each of the cartridge mounting portions 108 opens on the front of the housing 101. Note that FIG. 1 shows only one of the cartridge mounting portions 108 and one of the cartridge insertion ports 120 to avoid complexities in illustration. The length of the cartridge mounting portion 108 is, for example, about one-third of the length of the ink cartridge 1. The ink cartridge 1 is mounted to the cartridge mounting portion 108, and thus inserted inside the printer 100 in a state that enables ink supply. Then, the ink is supplied from the ink cartridge 1 to the printhead 114 via a tube within the printer 100. The eight ink cartridges 1 comprise, for example, four white ink cartridges, one cyan ink cartridge, one magenta ink cartridge, one yellow ink cartridge, and one black ink cartridge.

### <Ink Cartridge>

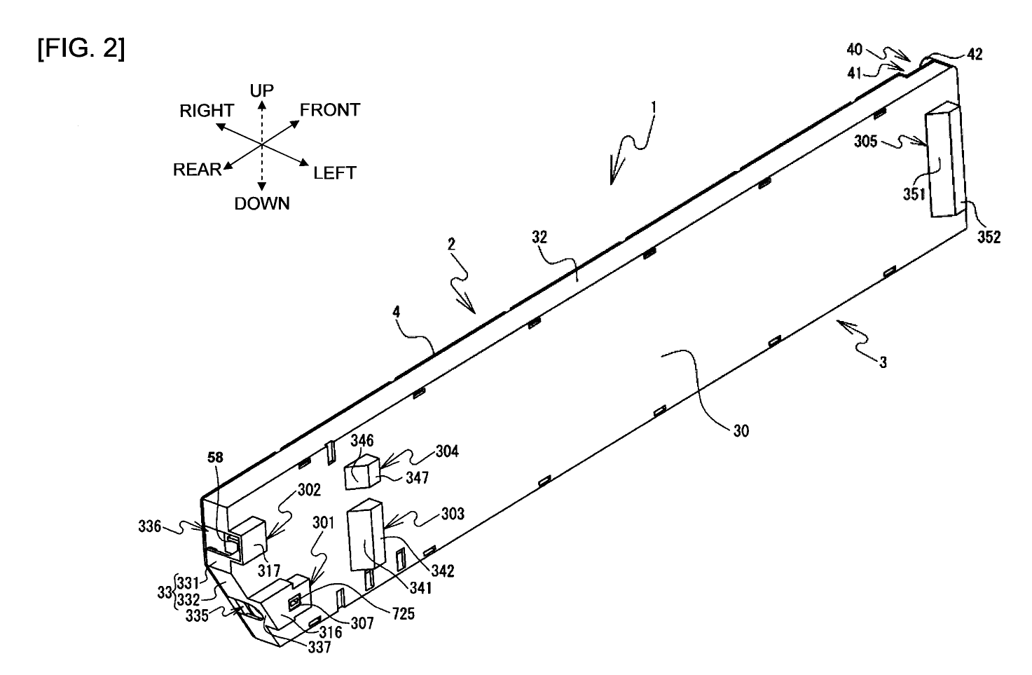

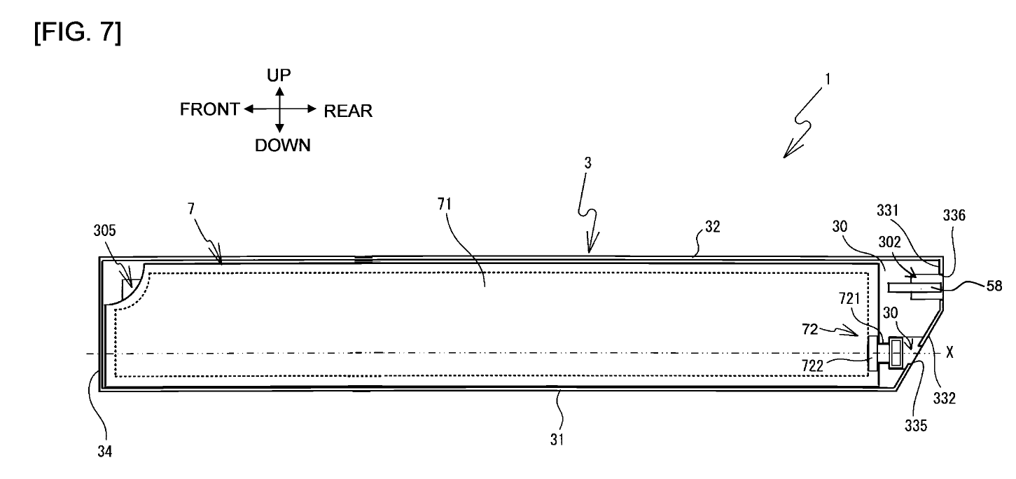

The following describes the overall configuration of the ink cartridge 1, using FIG. 2 to FIG. 6. As shown in FIG. 2 to FIG. 4, in this embodiment, the ink cartridge 1 comprises a housing 2 and an ink pack 7 (see FIG. 7 described later) housed within this housing 2. The housing 2 comprises a longwise direction, that is, a front-rear direction; a shortwise direction, that is, a vertical direction, orthogonal to the longwise direction; and a thickness direction, that is, a horizontal direction or width direction, that is orthogonal to the longwise direction and shortwise direction. The ink cartridge 1 comprises a thin and slender substantially right-angled parallelepiped shape, with a narrow width and a long front-rear direction. The ink cartridge 1, according to this example, is used with the longwise direction and thickness direction of the housing 2 substantially horizontal, and the shortwise direction substantially vertical (see FIG. 1).

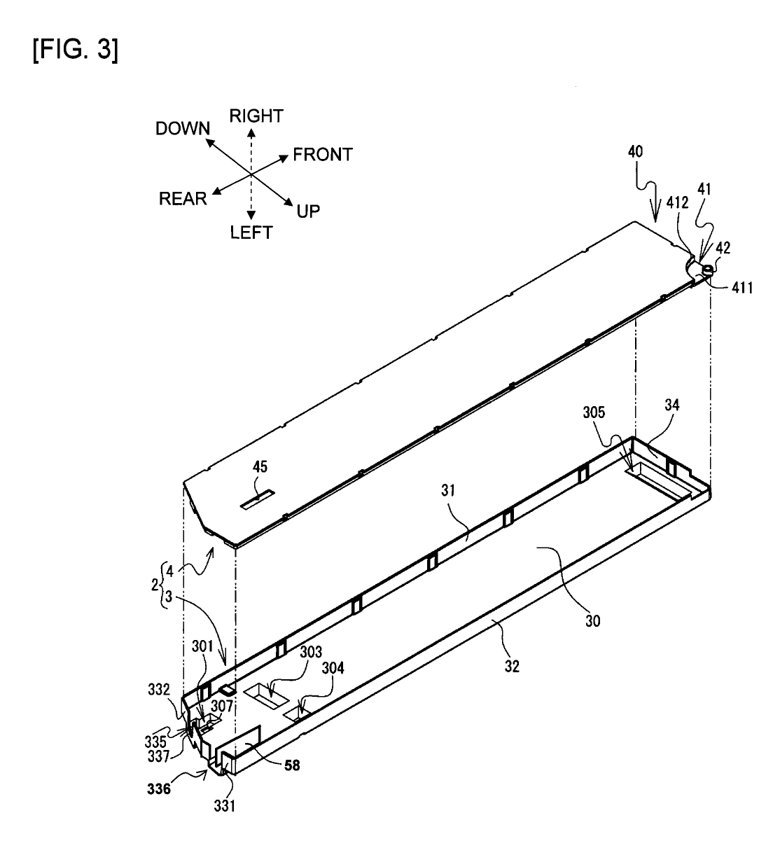

The above-described housing 2, as shown in FIG. 3, comprises a housing main body 3 and a cover 4. The housing main body 3 comprises a substantially thin, long, and narrow right-angled parallelepiped shape that fully opens on a lateral surface on the right side. The cover 4 comprises a long and narrow plate shape for covering the above-described opening. The housing main body 3 and the cover 4 are provided with an engaging hook and an engaging hole, or with an engaging pin and an engaging hole. The housing 2 is assembled by inserting these together and connecting the housing main body 3 and the cover 4 or by welding the housing main body 3 and the cover 4.

The housing main body 3 comprises a left wall portion 30, a bottom wall portion 31, an upper wall portion 32, a rear wall 33, and a front wall portion 34. The rear wall 33, which forms a lateral surface on one side of the housing 2 in the longwise direction, comprises a vertical upper rear wall portion 331, and a lower rear wall portion 332 in a slope direction, as shown in FIG. 2. The upper rear wall portion 331 connects with the upper wall portion 32 and the left wall portion 30, which is a lateral surface on one side of the housing 2 in the thickness direction. The lower rear wall portion 332 connects with the bottom wall portion 31 and the left wall portion 30 of the housing main body 3. The bottom wall portion 31 is somewhat shorter than the upper wall portion 32, and the rear end of the bottom wall portion 31 is positioned so that it recedes toward the front side of the housing main body 3. The lower rear wall portion 332 slopes inward from the upper rear wall portion 331 toward the bottom wall portion 31. The upper rear wall portion 331 is provided with an observation opening 336 that enables viewing of the inside of a reservoir portion 71 of an ink pack 7 from outside the housing 2. The lower rear wall portion 332 is provided with an ink discharge opening 335 for discharging the ink of the ink pack 7.

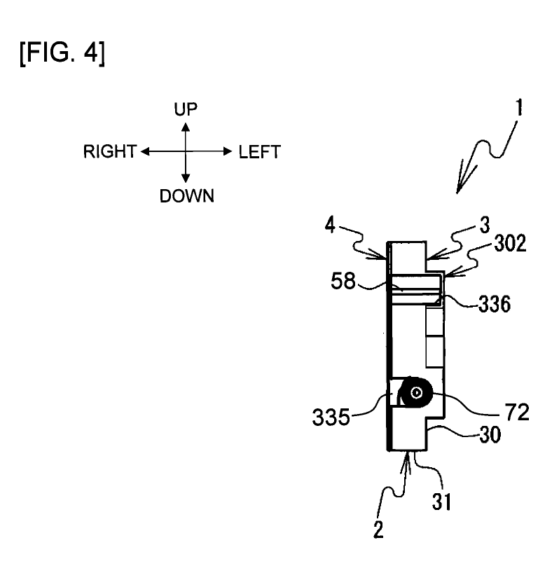

To prevent foreign matter from entering the housing 2 from the outside, a partition plate 58 established on the left wall portion 30 of the housing main body 3 is disposed inside the observation opening 336. The partition plate 58, as shown in FIG. 4, is formed into a substantially horizontal posture extending from the left side to the right side of the housing 2 within the observation opening 336. The partition plate 58 extends up to near the outlet of the observation opening 336, along the longwise direction of the housing 2. A mirror surface is provided to the front of this partition plate 58. The mirror surface is a surface that is not subjected to surface texturing, which is created by a sandblast process on the surface of the mold, for example. With this arrangement, light readily enters the housing due to the sheen of the mirror surface, improving the visibility of the housing interior. Further, the partition plate 58 may be installed as a separate member from the housing main body 3, or integrally formed with the housing main body 3. When integrally formed, the partition plate 58 is capable of preventing the occurrence installation forgetfulness of the partition plate 58. Note that the details of the function of the partition plate 58 will be described later. A stopper 72 provided on the rear end of the ink pack 7 faces the ink discharge opening 335.

As shown in FIG. 3, five protruding portions, including a first rear protruding portion 301, a second rear protruding portion 302, a first intermediate protruding portion 303, a second intermediate protruding portion 304, and a front protruding portion 305, are provided to the left wall portion 30 by indenting the inner surface thereof toward the outer surface side.

The first rear protruding portion 301 comprises a convex-shaped planar portion 316 that is parallel with the left wall portion 30. Further, the first rear protruding portion 301 is formed as a protruding portion that joins with the lower rear wall portion 332. The ink discharge opening 335 of the above-described lower rear wall portion 332 is formed into a lateral U-shape on the lower rear wall portion 332. With this arrangement, the U-shaped end portion in the protruding direction of the ink discharge opening 335 extends across the joining portion that joins with the rear lower rear wall portion 332 of the first rear protruding portion 301. Note that the vicinity of the end portion of the plug opening 335 on the left wall 30 side serves as a joining wall portion 337. Further, the first rear protruding portion 301 comprises a rectangular engaging hole 307.

The second rear protruding portion 302 comprises a convex-shaped planar portion 317 that is parallel with the left wall portion 30. Further, the second rear protruding portion 302 is formed as a protruding portion that joins with the upper rear wall portion 331. The ink volume detection opening 336 of the above-described upper rear wall portion 331 forms a lateral rectangular shape from the upper rear wall portion 331 to the second protruding portion 302. The first intermediate protruding portion 303 and the second intermediate protruding portion 304 are provided in locations near the rear portion of the left wall portion 30 and are separated vertically. The front protruding portion 305 is provided in a location near the front portion of the left wall portion 30. These first and second intermediate protruding portions 303 and 304 and front protruding portion 305 each comprise convex-shaped planar portions 342, 347, and 352 that are parallel with the left wall portion 30. Gentle sloped portions 341, 346, and 351 that slope toward the rear direction are formed on the rear sides of these convex-shaped planar portions 342, 347, and 352.

The convex-shaped planar portions 316, 317, 342, 347, and 352 of these protruding portions 301, 302, 303, 304, and 305 have the same height. With this arrangement, when a worker performs a task such as installing the cover 4 or placing the ink pack 7 within the housing main body 3, the worker performs the operation with the housing main body 3 laid on a horizontal plane, such as a work table, as shown in FIG. 3. Subsequently, the worker can stably support the housing main body 3 on the plane using the protruding portions 301 to 305 and effectively perform the task.

Note that the first and second intermediate protruding portions 303 and 304 comprise an identification function that permits color identification by the user. That is, when the second intermediate protruding portion 304 is short, the first intermediate protruding portion 303 is long, and the condition described later is satisfied, the ink color of the ink pack 7 housed within the housing 2 is white. The condition is that the second intermediate protruding portion 304 does not intersect with the strip region in the front-rear direction of the housing 2, which has a width between the boundary location of the upper and lower rear walls 331 and 332 and the lower end location of the second rear protruding portion 302. Further, if the second intermediate protruding portion 304 is long, the first intermediate protruding portion 303 is short, and the second intermediate protruding portion 304 intersects with the above-described strip region, the ink color of the ink pack 7 housed in the housing 2 is yellow, magenta, and cyan.

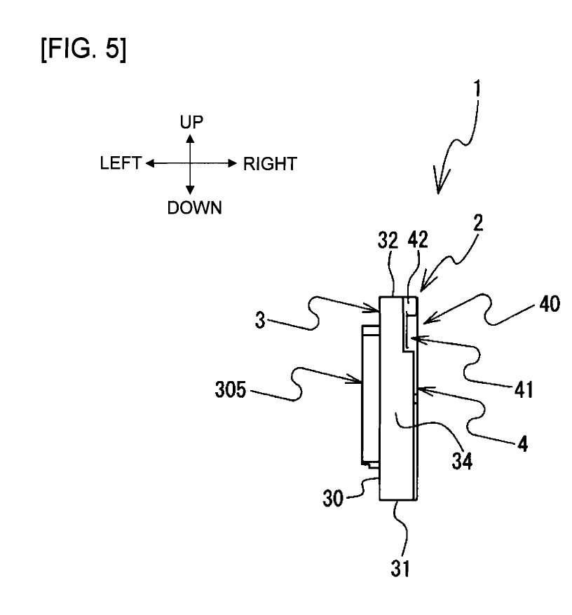

A gripping portion 40 of the housing 2 is provided to the upper front corner portion of the cover 4, as shown in FIG. 3. The gripping portion 40 comprises a fan-shaped recessed portion 41 and a protruding portion 42. The recessed portion 41 comprises a fan-shaped surface portion 411 of an included angle of 90° that indents the upper front corner portion of the cover 4 from the outer surface side toward the inner surface side, and a peripheral wall 412. The protruding portion 42 protrudes in the direction opposite the recessed direction, near the pivot of the fan of the recessed portion 41, and comprises a length that is shorter than the depth of the recessed portion 41. The upper front corner portion of the housing main body 3, as shown in FIG. 3 and FIG. 5, cuts out the upper wall portion 32 and the front wall portion 34 to ensure reception of both sides of the fan shape on the bottom surface of the recessed portion 41, thus receiving the recessed portion 41. With such the gripping portion 40 provided to the housing 2, the worker can securely grip and easily remove the cartridge 1. For example, even in a case where a plurality of cartridges 1 is mounted with slight gaps therebetween to the cartridge mounting portion 108 of the printer 100, for example, the worker can put one of his or her fingers used to pinch both sides of the housing 2 on the gripping portion 40.

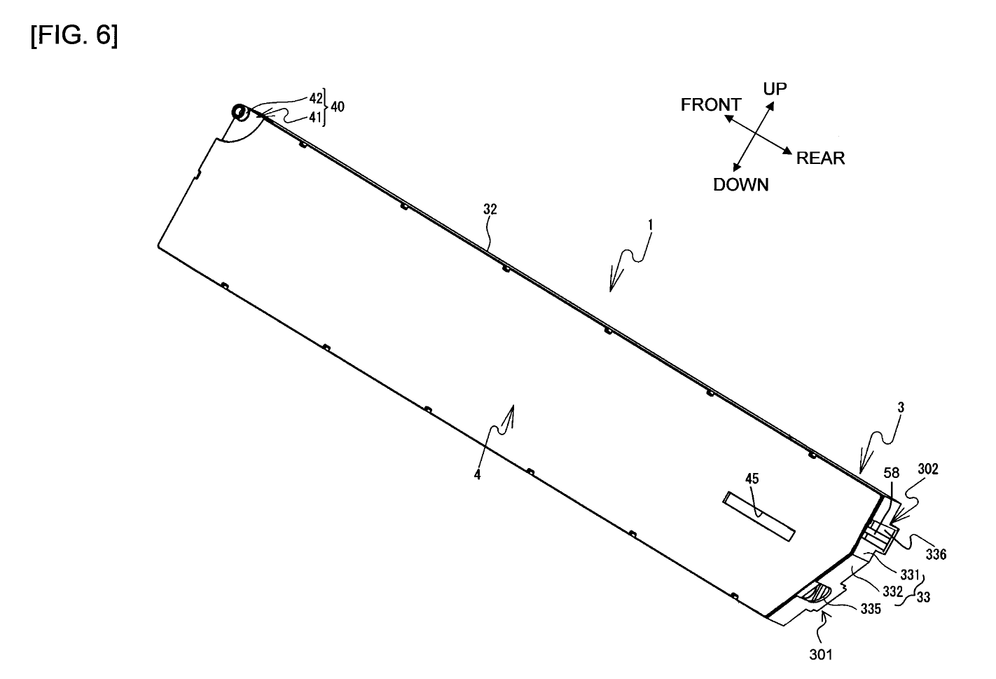

Further, an observation hole 45 that is long in the front-rear direction and passes through the cover 4 is provided at a location near the rear portion of the cover 4. With this arrangement, as shown in FIG. 6, it is possible to observe a portion of the ink pack 7 within the housing 2 through the observation hole 45.

### <Ink Pack>

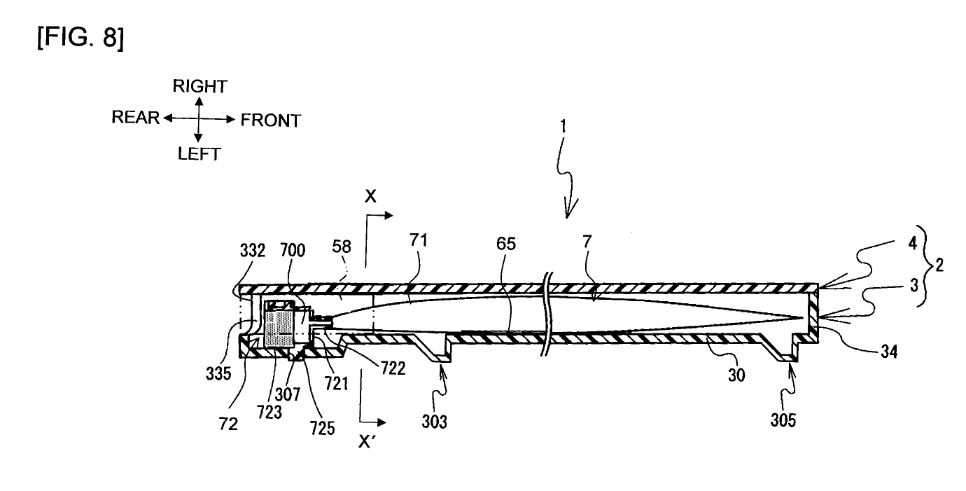

Next, the structure of the ink pack 7 and the surrounding area thereof will be described using FIG. 7 to FIG. 9. As shown in FIG. 7, the ink pack 7 comprises a long, narrow, bag-shaped reservoir portion 71 that stores ink, and the above-described plug 72 installed to the rear end portion of this reservoir portion 71. The ink pack 7 is disposed within the housing 2 with the left side of the reservoir portion 71 contacting the left wall portion 30 of the housing main body 3. An adhesive portion 65 (see FIG. 8) comprised of double-sided tape, for example, is preferably provided to the left wall portion 30, in the region along the longwise direction in contact with the reservoir portion 71. With this arrangement, the reservoir portion 71 can be fixed to the housing main body 3 by the adhesive portion 65.

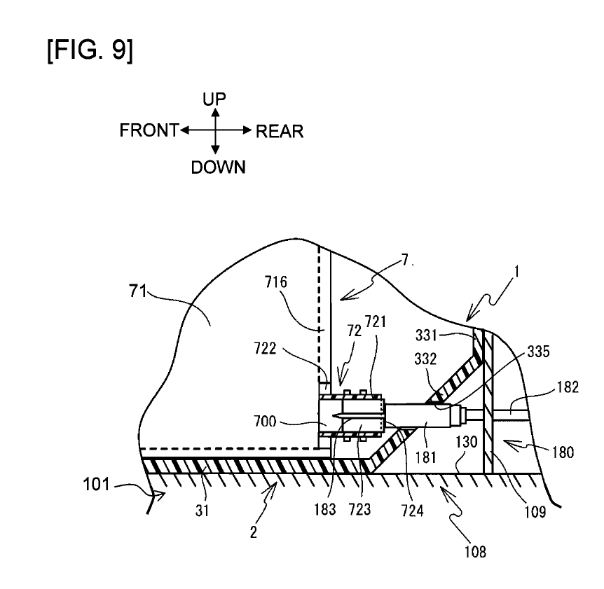

The above-described reservoir portion 71 is made of a transparent resin having flexibility. Specifically, two long, narrow, rectangular sheets of transparent resin having flexibility are prepared, and the front corner portion thereof is cut out in a fan shape in accordance with the gripping portion 40 of the cover 4. Then, the cutout two sheets are superimposed and a peripheral portion 716 (see FIG. 9) of the four sides thereof is heat-sealed, thereby forming the reservoir portion 71. According to this embodiment, the flexible transparent resin used is a resin of a three-layered structure comprising the layers of polyethylene-telephthalate (PET), nylon, and polyethylene, in that order from the outside.

The plug 72 comprises a resin, cylindrical main body portion 721 and a joining portion 722 that has a square cylindrical shape that is long in the vertical direction and has a narrow width. The cylindrical main body portion 721 is formed in a rectangular block shape having a rear side that is relatively large. The joining portion 722 is integrally provided with the front portion of the main body portion 721.

The main body portion 721 comprises a hollow portion 700 in its interior, as shown in FIG. 8. This hollow portion 700 links with a small hole that passes through the joining portion 722. The rubber stopper 723 that blocks the rear end portion of the hollow portion 700 is inserted into the rear portion of the main body portion 721. The joining portion 722 of the plug 72 is inserted between the two sheets that make up the reservoir portion 71 on the rear end portion of the reservoir portion 71, and heat-sealed per sheet. With this arrangement, the plug 72 is secured to the rear end portion of the reservoir portion 71 so that it is liquid tight, with an axial direction X thereof (see FIG. 7) aligned in the longwise direction, that is, the front-rear direction, of the reservoir portion 71. A prismatic joining protruding portion 725 is provided on the outer peripheral surface of the rectangular block-shaped section of the main body portion 721. The joining protruding portion 725 positions the plug 72 with respect to the housing 2, specifically with respect to the side wall portion 30 of the housing main body 3.

On the other hand, as shown in FIG. 9, a horizontal mounting table 130 and an abutment plate 109 are provided to the cartridge mounting portion 108 of the housing 101 of the printer 100. The mounting table 130 mounts the ink cartridge 1. The abutment plate 109 stands substantially vertically upward from the above-described mounting table 130 on the rear portion of the cartridge mounting portion 108. Further, a connecting portion 180 is provided to the rear end portion of the cartridge mounting portion 108. The connecting portion 180 is securely provided within the cartridge mounting portion 108 so that it is concentric with the plug 72, in front of the abutment plate 109. The connecting portion 180 comprises a cylindrical securing portion 181 to which an ink tube 182 is connected on the rear end, and a hollow lead needle 183 comprising a hole on the end side that protrudes frontward from the front center of the securing portion 181.

The ink cartridge 1 is inserted into the cartridge mounting portion 108, rear portion first. Then, the ink cartridge 1 is inserted into the cartridge mounting portion 108 with the rear portion of the housing 2 in contact with the abutment plate 109. A part of the securing portion 181 of the connecting portion 180 enters the housing 2 from the ink discharge opening 335 as the cartridge 1 is inserted. Then, the lead needle 183 on the front portion of the securing portion 181 is further inserted through the center of the rubber stopper 723 from an end portion 724 of the rubber stopper 723 of the main body portion 721 of the plug 72, positioning the end portion of the lead needle 183 within the hollow portion 700 of the main body portion 721. With this arrangement, the reservoir portion 71 of the ink pack 7 and the ink tube 182 on the printer 100 side are connected via the plug 72 and the connecting portion 108. As a result, the ink within the reservoir portion 71 is discharged to the ink tube 182 through the hollow portion 700 of the plug 72, the lead needle 183, and the securing portion 181 of the connecting portion 108 and supplied from the ink tube 182 to the printhead 114.

### <Function of Partition Plate>

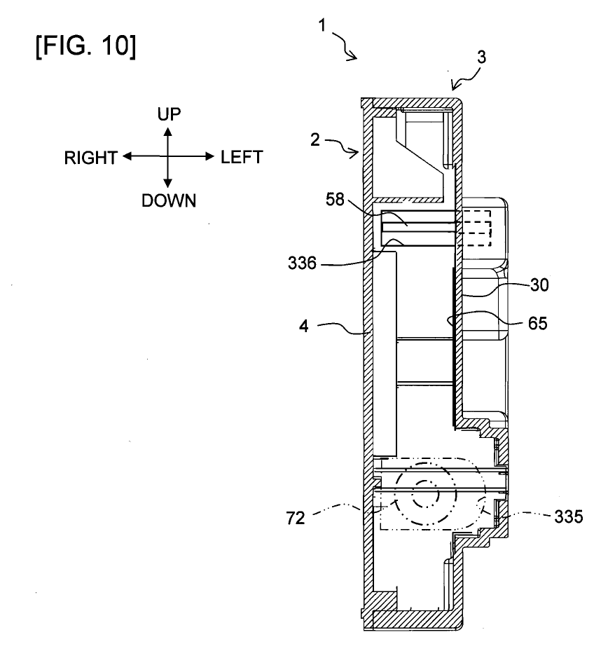

Next, the effect of this embodiment based on the function of the above-described partition plate 58 will be described in detail using FIG. 10, etc. As shown in FIG. 10, the aforementioned partition plate 58 is disposed in a substantially horizontal posture within the observation opening 336 of the rear portion of the housing 2. Then, the aforementioned plug 72 is positioned within the ink discharge opening 335 under thereof. The ink cartridge 1 of this embodiment is used with the longwise direction and thickness direction of the housing 2 substantially horizontal, and the shortwise direction substantially vertical, as described above. The ink pack 7 is provided within the housing 2, and the ink is stored in the reservoir portion 71 of that ink pack 7. The reservoir portion 71 is bag shaped and is disposed so that the end portion of the thickness direction contacts the housing 2. As a result, the reservoir portion 71 comprises a shape wherein the liquid level increases in height in proportion to the high volume of in ink in its interior, bulging in the above-described thickness direction, that is, the right/left direction or, in other words, the substantially horizontal direction. Conversely, the reservoir portion 71 comprises a shape wherein the liquid level decreases in height in proportion to the decrease in ink in its interior, shrinking in the above-described thickness direction.

According to this embodiment, the observation opening 336 is provided to the rear portion of a lateral surface on one side of the housing 2 in the longwise direction so that the operator can observe the behavior of the liquid level such as described above and the behavior of the bag-shaped reservoir portion 71 from the outside of the housing 2. That is, when the ink within the reservoir portion 71 of the ink pack 7 decreases via use of the ink of the printhead 114, for example, the slight amount of ink that remains often generally exists near the ink discharge opening 335. Since both the observation opening 336 and the ink discharge opening 335 are disposed on the rear portion of the housing 2, the operator can easily visually check the ink volume within the reservoir portion 71 that remains near the ink discharge opening 335 through the observation opening 336.

When the observation opening 336 is provided as described above, the possibility exists that foreign matter will enter the housing 2 from the opening 336 during transport prior to sale or during handling by the operator after sale. Further, the possibility exists that the bag-shaped reservoir portion 71 will incur damage or breakage by the shape or size of the foreign matter or its speed of entry. Here, according to this embodiment, the partition plate 58 that partitions the opening area of the observation opening 336 into a plurality of regions extends substantially horizontally within the opening 336. Note that the partition plate 58 may be provided apart from the opening 336. That is, as shown in FIG. 10, when a visual check is made in the longwise direction from the rear portion of the housing 2, it is only necessary to extend the partition plate 58 so that it is disposed within the opening 336 in the longwise direction of the housing 2. Further, this partition plate 58 may be formed by an elastic member, such as rubber. With this arrangement, it is possible to prevent such entry of foreign matter as described above and maintain the visibility of the reservoir portion 71 for the operator.

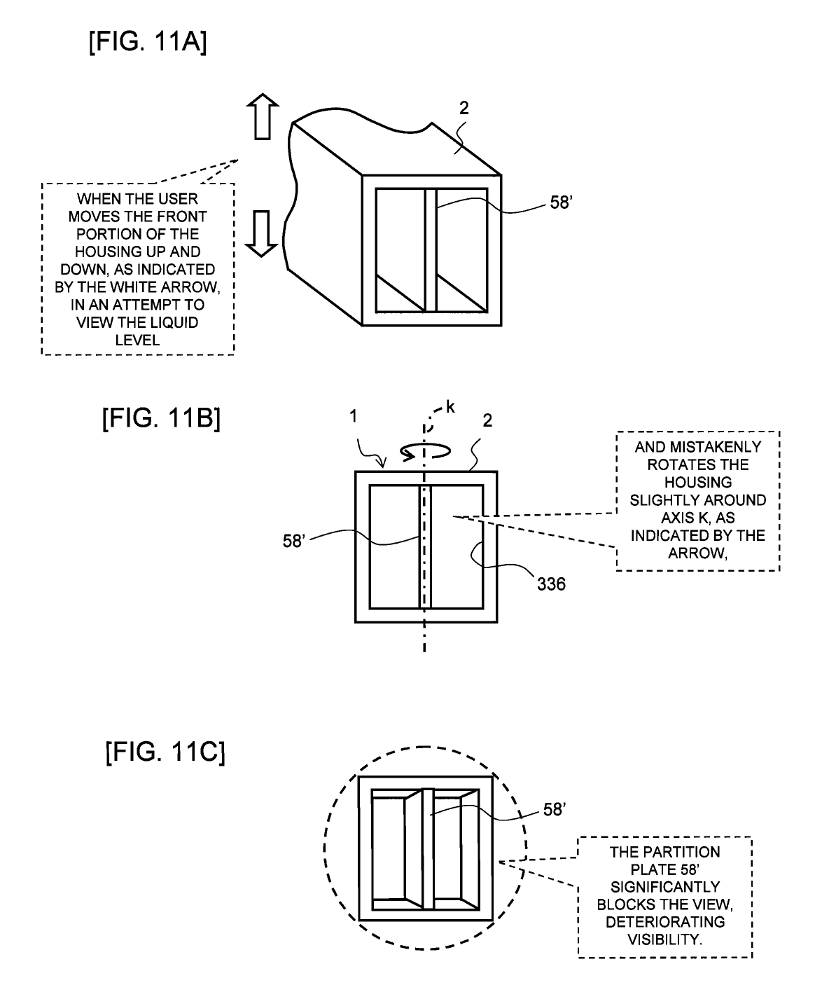

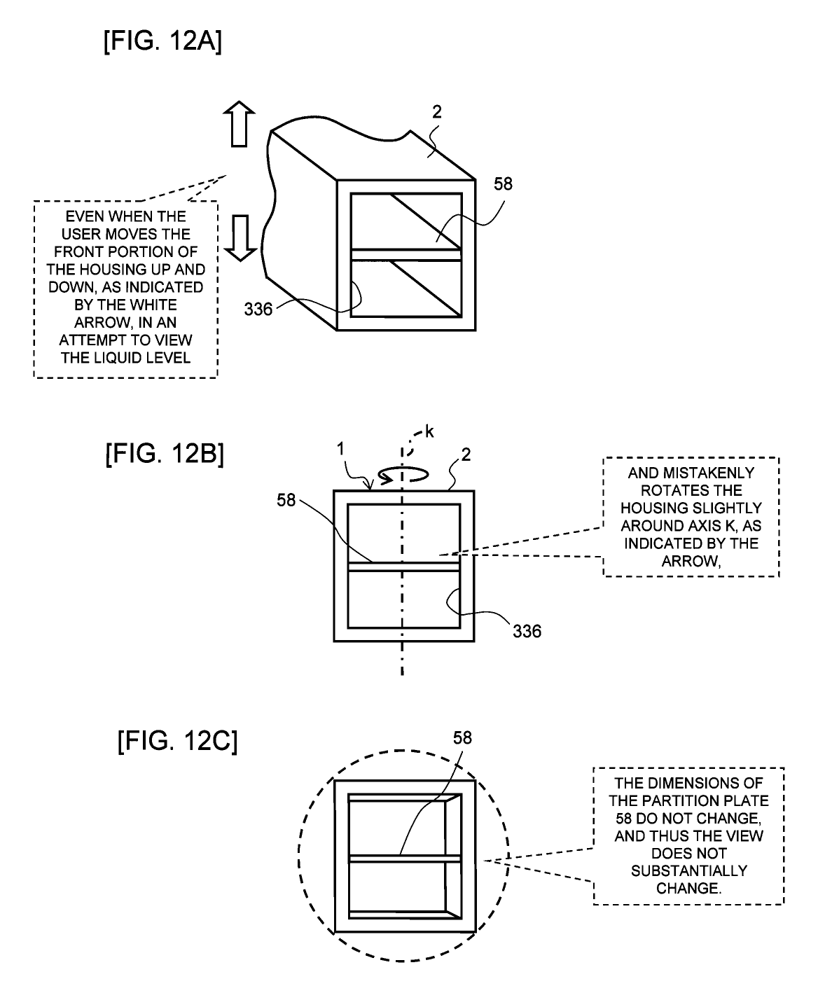

When the ink within the reservoir portion 71 decreases as described above, the operator normally orientates the ink discharge opening 335 side toward him- or herself, that is, in front of him or her. Then, the operator raises or lowers the opposite front side, that is, the other side of the housing 3 in the longwise direction (see the white arrow in FIG. 11A and FIG. 12A described later), changing the posture of the cartridge 1. With this arrangement, the operator agitates the ink housed in the reservoir portion 71, attempting to visually check the remaining ink volume. Here, as shown in FIG. 11A, for example, a partition plate 58′ is extended substantially vertically within the observation opening 336 on the rear portion of the housing 2. In such a comparison example, let's assume that the cartridge 1 is mistakenly rotated slightly in the horizontal direction around an axis k, as shown in FIG. 11B, when the operator changes the posture of the cartridge 1 as described above. In this case, as shown in FIG. 11C, when the operator views the reservoir portion 71 through the observation opening 336, the possibility exists that the partition plate 58′ will significantly block the view, deteriorating visibility.

Conversely, according to this embodiment, as shown in FIG. 12A, the partition plate 58 is extended substantially vertically within the observation opening 336 on the rear portion of the housing 2. Accordingly, even in a case where the above-described cartridge 1 rotates in horizontally around the axis k as shown in FIG. 12B when the operator changes the posture of the above-described cartridge 1, as shown in FIG. 12C, the blocking of the view by the partition plate 58 is avoided when the operator views the reservoir portion 71 through the observation opening 336. As a result, it is possible to suppress the decrease in visibility when the reservoir portion 71 within the housing 2 is viewed.

Also notably, the embodiment provides the following advantages as well. That is, given that the reservoir portion 71 is made of a rigid material, the reservoir portion 71 is not readily susceptible to deformation even when the ink decreases. This makes it difficult to verify the remaining ink volume if the reservoir portion 71 is not a transparent pack. Conversely, according to the embodiment, the reservoir portion 71 is made of a flexible material, causing deformation of the reservoir portion 71 when the ink volume decreases. With this arrangement, whether the reservoir portion 71 is a transparent pack or a non-transparent pack, such as silver, the remaining ink volume can be verified.

Further, in particular, according to this embodiment, the reservoir portion 71 is made of a resin material having a three-layered structure of PET, nylon, and polyethylene layered in that order from the outside. With this arrangement, flexibility and transparency are favorably provided to the reservoir portion 71, making it possible to easily verify the remaining ink volume.

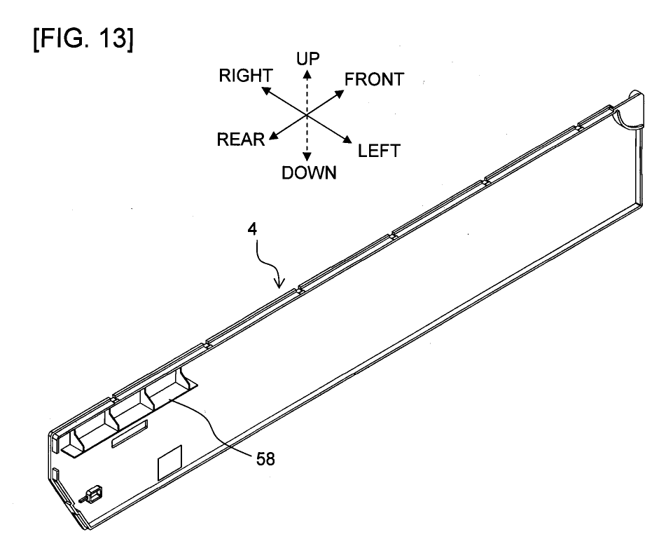

Note that while, in the above, the partition plate 58 is provided to the housing main body 3 of the housing main body 3 and cover 4 that make up the housing 2, the present invention is not limited thereto. That is, as shown in FIG. 13, the partition plate 58 may be provided to the cover 4. With this arrangement, when the reservoir portion 71 is provided to the interior of the housing 2, the partition plate 58 can be made to not cause interference. Further, the partition plate 58 may be integrally formed with the cover 4. In such a case, it is possible to prevent workers from forgetting to install the partition plate 58, similar to the above.

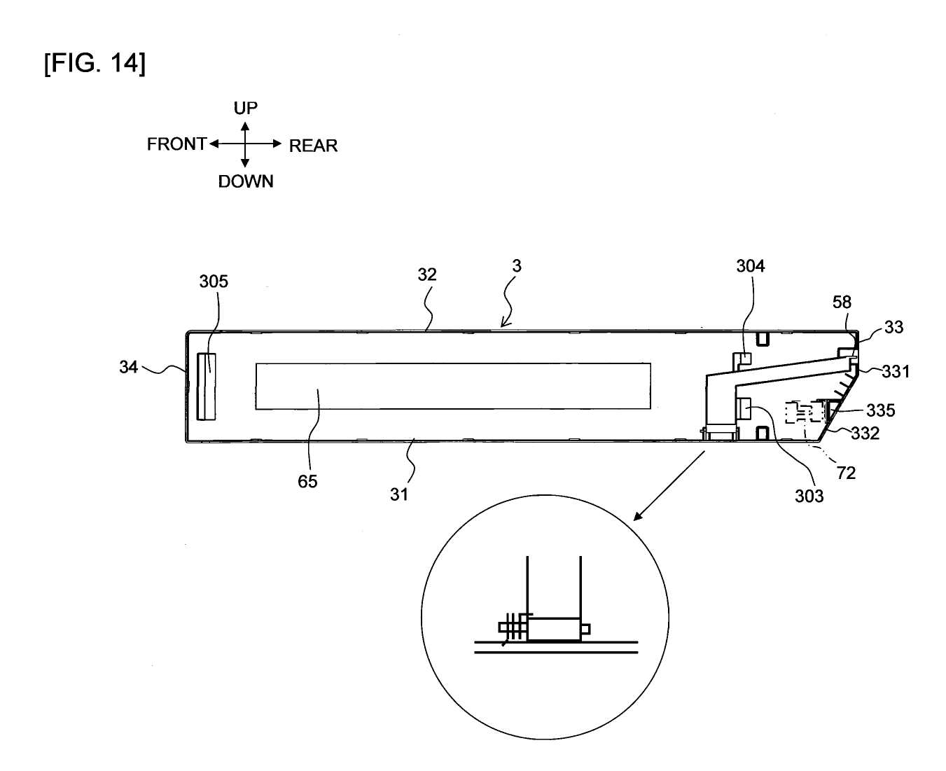

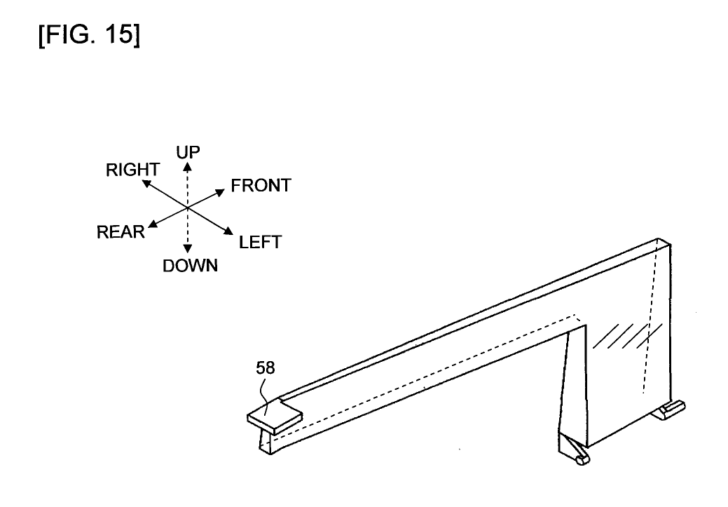

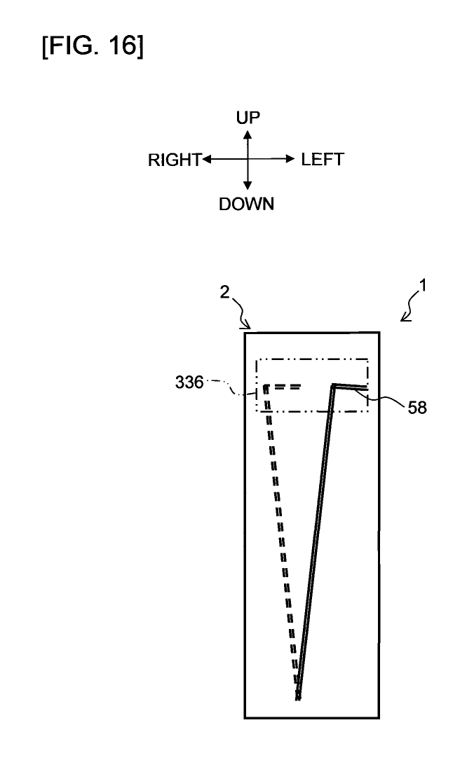

Further, while the above has described an illustrative scenario in which the partition plate 58 is provided in a fixed manner horizontally across the left side to the right side of the housing 2 within the observation opening 336, the present invention is not limited thereto. For example, as shown in FIG. 14, FIG. 15, FIG. 16, etc., the partition plate 58 rotatably supported at the lower end portion may be provided in the interior of the housing 2. In each of these cases as well, the same advantages are achieved.

Note that various modifications which are not described in particular can be made according to the present invention without departing from the spirit and scope of the invention.

What is claimed is:

1. An ink cartridge for supplying ink, comprising:
a housing having a longwise direction, a shortwise direction orthogonal to said longwise direction, and a thickness direction respectively orthogonal to said longwise direction and said shortwise direction, that has an opening to a lateral surface on one side of said housing in said longwise direction; and
a substantially bag-shaped reservoir portion configured to store the ink in its interior, disposed within said housing so that an end portion in said thickness direction contacts said housing; and
a partition plate configured to extend so as to be disposed within said opening along said longwise direction, so that it is possible to visually check an interior of said reservoir portion from an outside of said housing.

2. The ink cartridge according to claim 1, wherein:
said housing has a discharge portion configured to externally discharge the ink, below said opening on the lateral surface of the one side in said longwise direction.

3. The ink cartridge according to claim 2, wherein:
said reservoir portion is made of a flexible material.

4. The ink cartridge according to claim 3, wherein:
said reservoir portion is made of a transparent resin material.

5. The ink cartridge according to claim 1, wherein:
said partition plate is provided to a surface of said housing that is opposite a surface that is in contact with said reservoir portion.

6. The ink cartridge according to claim 1, wherein:
said partition plate is integrally provided to a surface of said housing that is in contact with said reservoir portion or a surface opposite a surface that is in contact with said reservoir portion.

7. The ink cartridge according to claim 1, wherein:
a mirror surface is provided to a front surface of said partition plate.
